(19) United States
(12) Patent Application Publication
(10) Pub. No.: US 2021/0281743 A1
(43) Pub. Date: Sep. 9, 2021

(54) IMAGING CONTROL DEVICE, IMAGING DEVICE, AND IMAGING CONTROL METHOD

(71) Applicant: SONY SEMICONDUCTOR SOLUTIONS CORPORATION, KANAGAWA (JP)

(72) Inventor: RYUICHI TADANO, KANAGAWA (JP)

(21) Appl. No.: 16/323,351

(22) PCT Filed: May 11, 2017
(86) PCT No.: PCT/JP2017/017828

§ 371 Date: Feb. 5, 2019

(30) Foreign Application Priority Data
Aug. 26, 2016 (JP) 2016-165490

(51) Int. Cl. H04N 5/232; G06T 5/00; G06K 9/00

(52) U.S. Cl. CPC H04N 5/23219; G06K 9/00624; G06K 9/00228; G06T 5/006

(57) ABSTRACT

To reduce the power consumption of an imaging device that outputs image signals in a partial region of an imaging region. An imaging control device includes a noticed region detecting section and an image signal control section. The noticed region detecting section detects a noticed region from an image signal outputted from an image sensor, the noticed region being a region that is noticed by a specific living thing included in the image signal. The image signal control section performs control of output from the image sensor of an image signal in the detected noticed region, and performs control different from control in the noticed region, for an image signal in a non-noticed region that is a region other than the noticed region.

### TECHNICAL FIELD

The present technology relates to an imaging control device, an imaging device, and an imaging control method. In detail, it relates to an imaging control device, an imaging device, and an imaging control method, which output image signals in a partial region of an imaging region.

### BACKGROUND ART

Hitherto, imaging devices that include a wide angle lens, such as a fisheye lens and capture a wide viewing-angle image, have been used. In such imaging devices, proposed has been an imaging device that displays a person to be imaged and a thing or other person being noticed by this person simultaneously and causes convenience to be improved. For example, proposed has been a system that performs prediction of a line-of-sight direction of a person to be imaged, estimates a relevant thing been noticed by the concerned person from this line-of-sight direction, and displays it with the person simultaneously (for example, refer to Patent Literature 1).

### CITATION LIST

### Patent Literature

Patent Literature 1: JP 2012-124767A

### DISCLOSURE OF INVENTION

### Technical Problem

The above-mentioned related technology acquires the image signals of a person and a relevant thing from the captured image signals of a wide viewing angle, displays this person, in addition, forms a child screen within a display screen, and displays the relevant thing on this child screen. For this reason, in the above-mentioned related technology, a lot of processing is required for displaying the screens, which causes a problem that power consumption increases.

The present technology is one that has been created in view of such a situation, and an object is to reduce the power consumption of an imaging device that outputs image signals in a partial region of an imaging region.

### SOLUTION TO PROBLEM

The present technology has been made to solve the above problem. According to a first aspect thereof, there is provided an imaging control device and an imaging control method, the imaging control device including: a noticed region detecting section that detects a noticed region from an image signal outputted from an image sensor, the noticed region being a region that is noticed by a specific living thing included in the image signal; and an image signal control section that performs control of output from the image sensor of an image signal in the detected noticed region, and performs control different from control in the noticed region, for an image signal in a non-noticed region that is a region other than the noticed region. With this, brought is an action that control of image signals different from control of image signals in the noticed region is performed for the non-noticed region.

In addition, according to the first aspect, the image signal control section may perform control for causing the image sensor to stop outputting an image signal in the non-noticed region. With this, brought is an action that in the image signals in the non-noticed region, the output from the image sensor is stopped.

In addition, according to the first aspect, the image signal control section may perform control for causing an image signal of the non-noticed region to be outputted on the basis of resolution different from resolution in the noticed region. With this, brought is an action that image signals of the non-noticed region with the resolution different from the resolution in the noticed region are outputted.

In addition, according to the first aspect, the image signal control section may perform control for causing an image signal of the non-noticed region to be outputted on the basis of a frame rate different from a frame rate in the noticed region. With this, brought is an action that image signals of the non-noticed region with a frame rate different from a frame rate in the noticed region are outputted.

In addition, according to the first aspect, the imaging control device may further include a distortion correcting section that corrects distortion of the outputted image signal in the noticed region. With this, brought is an action that the distortion of the image signals of the noticed region is corrected.

In addition, according to the first aspect, the image sensor may output an image signal having been captured through a fisheye lens, and the distortion correcting section may correct distortion of an image signal caused by the fisheye lens. With this, brought is an action that the distortion caused by the fisheye lens is corrected.

In addition, according to the first aspect, the noticed region detecting section may detect the noticed region on the basis of face information that is information with regard to a face of the specific living thing. With this, brought is an action that the noticed region is detected on the basis of the information with regard to a face.

In addition, according to the first aspect, the noticed region detecting section may detect the noticed region on the basis of a pointing direction of the specific living thing. With this, brought is an action that the noticed region is detected on the basis of a pointing direction.

In addition, according to the first aspect, the noticed region detecting section may select the specific living thing from an image signal outputted from the image sensor, and detect the noticed region on the basis of the selected specific living thing. With this, brought is an action that a specific living thing is selected.

In addition, according to the first aspect, the noticed region detecting section may select a photographer as the specific living thing. With this, brought is an action that a photographer is selected as a specific person.

In addition, according to the first aspect, in a case where a plurality of living things is included in an image signal outputted from the image sensor, the noticed region detecting section may select one of the plurality of living things as the specific living thing. With this, brought is an action that one of a plurality of living things is selected.

In addition, according to the first aspect, the noticed region detecting section may change a frequency of detecting the noticed region. With this, brought is an action that a detection frequency of a noticed region is changed.

In addition, according to the first aspect, the specific living thing may be a specific person. With this, brought is an action that a region being noticed by a specific person is detected as a noticed region.

In addition, according to a second aspect of the present technology, an imaging device includes: an image sensor; a noticed region detecting section that detects a noticed region from an image signal outputted from the image sensor, the noticed region being a region that is noticed by a specific living thing included in the image signal; and an image signal control section that performs control of output from the image sensor of an image signal in the detected noticed region, and performs control different from control in the noticed region, for an image signal in a non-noticed region that is a region other than the noticed region. With this, brought is an action that control of image signals different from control of image signals in the noticed region is performed for the non-noticed region.

### Advantageous Effects of Invention

According to the present technology, it is possible to exert an excellent effect that the power consumption of an imaging device that outputs image signals in a partial region of an imaging region, is reduced. In this connection, the effect described here is not necessarily limited, and may be any of effects described in the present disclosure.

### BRIEF DESCRIPTION OF DRAWINGS

FIG. 1 is a diagram showing a constitution example of an imaging device 10 in an embodiment of the present technology.

FIG. 2 is a diagram showing a constitution example of an imaging control section 300 in the first embodiment of the present technology.

FIG. 3 is a diagram showing a constitution example of a noticed region detecting section 310 in the first embodiment of the present technology.

FIG. 4 is an illustration showing one example of a noticed region in the first embodiment of the present technology.

FIG. 5 is a diagram showing one example of imaging control in the first embodiment of the present technology.

FIG. 6 is a diagram showing one example of a processing procedure of imaging control processing in the first embodiment of the present technology.

FIG. 7 is a diagram showing other example of a processing procedure of imaging control processing in the first embodiment of the present technology.

FIG. 8 is an illustration showing one example of a noticed region in the second embodiment of the present technology.

FIG. 9 is a diagram showing one example of a processing procedure of imaging control processing in the second embodiment of the present technology.

FIG. 10 is a diagram showing a constitution example of a noticed region detecting section 310 in the third embodiment of the present technology.

FIG. 11 is an illustration showing one example of a noticed region in the third embodiment of the present technology.

FIG. 12 is a diagram showing one example of a processing procedure of imaging control processing in the third embodiment of the present technology.

FIG. 13 is a diagram showing one example of an imaging control in the fourth embodiment of the present technology.

### MODE(S) FOR CARRYING OUT THE INVENTION

Hereinafter, a mode (in the below, referred to as an embodiment) for carrying out the present technology will be described. The description will be given in the following order.

1. First embodiment (example in case where noticed region is detected from face region of photographer)

2. Second embodiment (example in case of selecting specific person)

3. Third embodiment (example in case where noticed region is detected from pointing direction of photographer)

4. Fourth embodiment (example in case of reducing sensing operation)

5. Modified example

### 1. First Embodiment

[Constitution of Imaging Device]

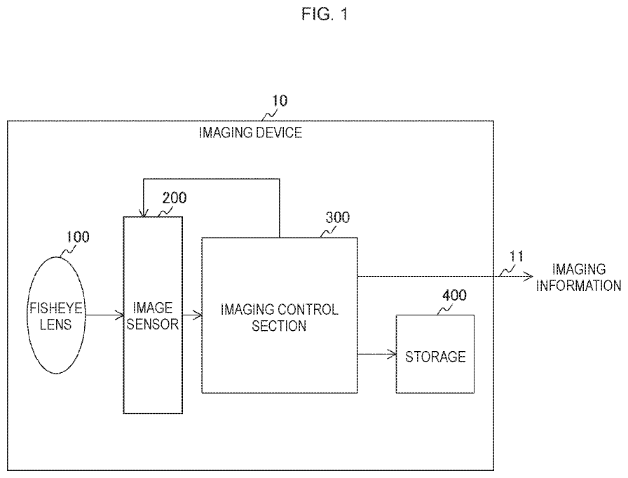

FIG. 1 is a diagram showing a constitution example of an imaging device 10 in an embodiment of the present technology. This imaging device 10 includes a fisheye lens 100, an image sensor 200, an imaging control section 300, and a storage 400.

The fisheye lens 100 is one that forms an image to the image sensor 200. This fisheye lens 100 is a lens of a projection system being not a central projection system, and is a lens that forms an image of a wide viewing angle.

The image sensor 200 captures (or images) an image formed by the fisheye lens 100. In order to capture an image through the fisheye lens 100, the captured image becomes a wide viewing angle image. This image sensor 200 is controlled by the imaging control section 300, performs imaging and processing of image signals after the imaging, and outputs the image signal after the processing. As this processing of image signals, it is possible to perform analog-to-digital conversion that converts analog image signals into digital image signals. Moreover, this processing of image signals can be performed for either a frame being image signals corresponding in amount to one screen or image signals of a selected region. To this selected region, for example, a noticed region mentioned later corresponds.

The imaging control section 300 is one that controls the image sensor 200. This imaging control section 300 performs the control of imaging and processing of image signals in the image sensor 200. In concrete terms, the imaging control section 300 performs the control that makes the image sensor 200 output the image signals of a noticed region. Here, the noticed region is a region that a specific person included in a frame is noticing, and is a region that becomes an object of image processing, preservation, or the like in the imaging device 10. Moreover, the specific person is one who uses the imaging device 10. To this specific person, for example, a photographer corresponds. The imaging control section 300 performs image processing, such as distortion correction, for the image signals of a noticed region, and outputs the image signals to the storage 400. A noticed region can be detected from, for example, the image signals of a region of the face of a photographer included in a frame outputted from the image sensor 200. On the other hand, with respect to the image signals of a non-noticed region being a region other than a noticed region, the imaging control section 300 performs control different from the control in the noticed region. In this connection, the details of the control for the image signals of these noticed regions and non-noticed region and the details of the constitution of the imaging control section 300 are mentioned later. Moreover, from the imaging control section 300, imaging information mentioned later is outputted through a signal line 11.

The storage 400 is one that holds the image signals of a noticed region outputted from the imaging control section 300.

In this connection, the constitution of the imaging device 10 is not limited to this example. For example, it is also possible to supply image signals outputted from the imaging control section 300 to the outside of the imaging device 10 with a signal line.

[Constitution of Imaging Control Section]

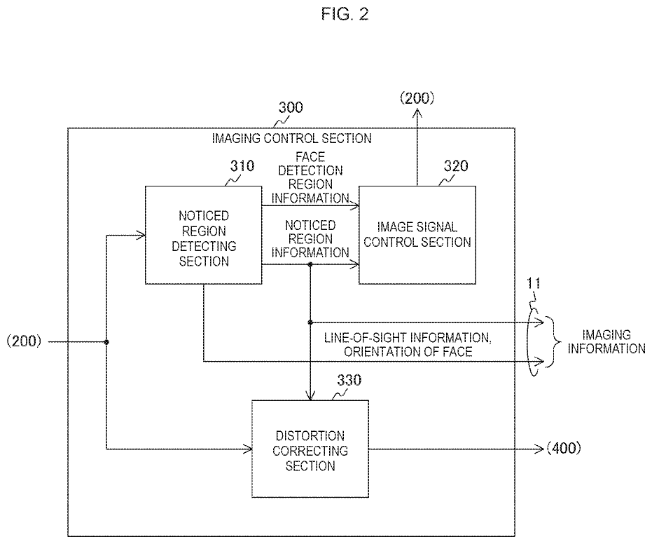

FIG. 2 is a diagram showing a constitution example of the imaging control section 300 in the first embodiment of the present technology. This imaging control section 300 includes a noticed region detecting section 310, an image signal control section 320, and a distortion correcting section 330.

The noticed region detecting section 310 is one that detects a noticed region. This noticed region detecting section 310 generates noticed region information showing a position of a detected noticed region, and outputs it to the image signal control section 320. The generation of the noticed region information, for example, can be performed as follows. First, a region of a photographer being a specific person is detected from a frame outputted from the image sensor 200. Next, from the region of the photographer, a region of the face of the photographer is detected. Next, from the region of the face of the photographer, a noticed region is detected, and information with regard to the position of the concerned region is generated as noticed region information. Moreover, the noticed region detecting section 310 generates position information with regard to the detected face region of the photographer as face detection region information, and further outputs it to the image signal control section 320. Moreover, the noticed region detecting section 310 can also output the imaging information generated in the process of detecting the noticed region to the outside of the imaging device 10. In the same diagram, line-of-sight information, the orientation of a face, and noticed region information are outputted through a signal line 11 as imaging information. In this connection, the imaging information is not limited to this example. For example, it is also possible to output any one of the line-of-sight information, the orientation of a face, and the noticed region information as the imaging information. The details of the constitution of the noticed region detecting section 310 will be mentioned later.

The image signal control section 320 is one that controls the image sensor 200 and causes the image signals of a noticed region to be outputted. This image signal control section 320 controls the image sensor 200 on the basis of the noticed region information outputted from the noticed region detecting section 310, and causes the image signals of a noticed region to be outputted. This, for example, can be performed by performing the calculation of a reading-out window on the basis of the noticed region information and by inputting it into the image sensor 200.

Moreover, for the image signals of a non-noticed region, the image signal control section 320 performs control different from the control for the image signals of the above-mentioned noticed region. For example, against the image sensor 200, the image signal control section 320 can perform the control that causes the output of the image signals of a non-noticed region to be stopped. With this, it is possible to omit analog-to-digital conversion processing etc. of the image signals of a non-noticed region other than the face detection region in the image sensor 200. With this, it becomes possible to reduce the power consumption of the imaging device 10. Moreover, only the image signals of a noticed region will be held in the storage 400, and the capacity of the storage 400 can be reduced.

Moreover, the image signal control section 320 can make the resolution of the image signals of a non-noticed region different from the resolution of a noticed region, for example, lower than the resolution of a noticed region. This, for example, can be performed by thinning out lines that cause image signal to be outputted, in a non-noticed region. Moreover, the image signal control section 320 can cause the image signals of a non-noticed region to be outputted on the basis of a frame rate different from the frame rate in a noticed region, for example, a low frame rate. With these, it is possible to reduce the power consumption of the image sensor 200.

Moreover, the image signal control section 320 further performs the control of the output of the image signals of a face detection region on the basis of the face detection region information outputted from the noticed region detecting section 310. The output of the image signals of this face detection region is one to be performed for detecting a noticed region, and is controlled in distinction from the image signals of the above-mentioned non-noticed region. In concrete terms, the image signals of a noticed region and a face detection region are made to be outputted from the image sensor 200, and in addition, the output of the image signals of other non-noticed region can be stopped. In this connection, in the case where there is no trouble in detection of a noticed region, the resolution and frame rate of a face detection region can be changed to a low value.

The distortion correcting section 330 is one that corrects the distortion of the image signals of a noticed region. This distortion correcting section 330 can select the image signal of a noticed region among the image signals outputted from the image sensor 200, and can perform the correction of distortion. The selection of the image signals of a noticed region can be performed, for example, by selecting image signals included in a reading-out window based on the noticed region information outputted from the noticed region detecting section 310. With this, the correction of the image signals of a non-noticed region can be omitted, and the power consumption of the imaging device 10 can be reduced more. In the correction of distortion, publicly-known methods can be used. For example, the distortion correcting section 330 can perform fisheye distortion correction that corrects distortion caused by the fisheye lens 100. The image signals of a noticed region after the correction are outputted to the storage 400.

In this connection, the imaging control section 300 is one example of an imaging control device described in claims.

[Constitution of Noticed Region Detecting Section]

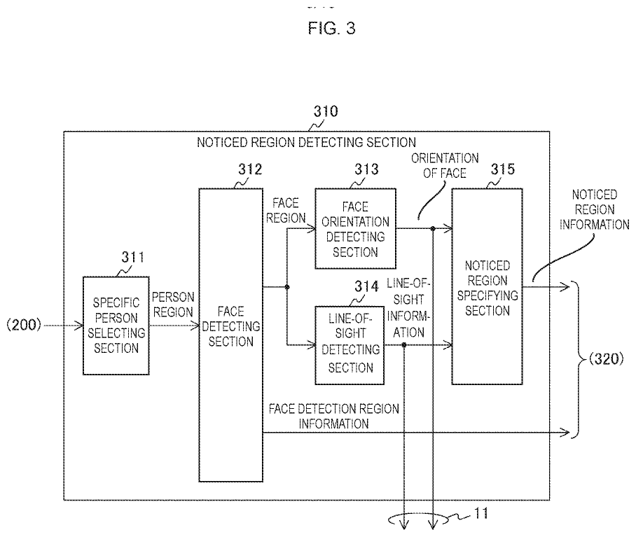

FIG. 3 is a diagram showing a constitution example of the noticed region detecting section 310 in the first embodiment of the present technology. This noticed region detecting section 310 includes a specific person selecting section 311, a face detecting section 312, a face orientation detecting section 313, a line-of-sight detecting section 314, and a noticed region specifying section 315.

The specific person selecting section 311 is one that selects a specific person included in the image signals outputted from the image sensor 200. This specific person selecting section 311 outputs the region of a selected specific person to the face detecting section 312. The specific person selecting section 311, for example, can select a photographer, and can output its region. Moreover, in the case where the region of the photographer is decided beforehand, the specific person selecting section 311 can output the image signals of the corresponding region. For example, in the case where a photographer wears the imaging device 10 and performs imaging, the photographer will be included in an upper end portion etc. of a screen. In such a case, it is possible to output a fixed region such as an upper end portion of a screen.

The face detecting section 312 is one that performs the detection of a face region from a person region outputted from the specific person selecting section 311. In the detection of a face region, publicly-known methods, for example, a pattern matching method can be used. This face detecting section 312 outputs the image signals of the detected face region to the face orientation detecting section 313 and the line-of-sight detecting section 314. Moreover, from the image signals of the detected face region, the face detecting section 312 detects the position of the concerned region in a frame, and outputs it as face detection region information to the image signal control section 320.

The face orientation detecting section 313 is one that detects the orientation of a face from the image signals of a face region outputted from the face detecting section 312. This face orientation detecting section 313 outputs the detected face orientation to the noticed region specifying section 315. Moreover, this face orientation detecting section 313 outputs the detected face orientation through the signal line 11 to the outside of the imaging device 10. In the detection of the orientation of a face, publicly-known methods can be used. For example, by detecting the orientation of a nose, the orientation of a face can be detected. Moreover, for example, by detecting the orientation of a jaw, the orientation of a face can be also detected.

The line-of-sight detecting section 314 is one that detects a line of sight from the image signals of a face region outputted from the face detecting section 312. This line-of-sight detecting section 314 outputs information with regard to the detected line of sight as line-of-sight information to the noticed region specifying section 315. Moreover, this line-of-sight detecting section 314 outputs the line-of-sight information through the signal line 11 to the outside of the imaging device 10. In the detection of a line of sight, publicly-known methods can be used. For example, a line of sight of a person can be detected from a distance between an inner corner of an eye and the center of a black eye.

The noticed region specifying section 315 is one that specifies a noticed region. From either or both of the orientation of a face outputted from the face orientation detecting section 313 or line-of-sight information outputted from the line-of-sight detecting section 314, this noticed region specifying section 315 specifies a noticed region. Next, from the specified noticed region, the noticed region specifying section 315 detects the position of the concerned region on a frame, and outputs it as noticed region information to the image signal control section 320. Moreover, the noticed region specifying section 315 outputs the noticed region information through the signal line 11 to the outside of the imaging device 10.

[Noticed Region]

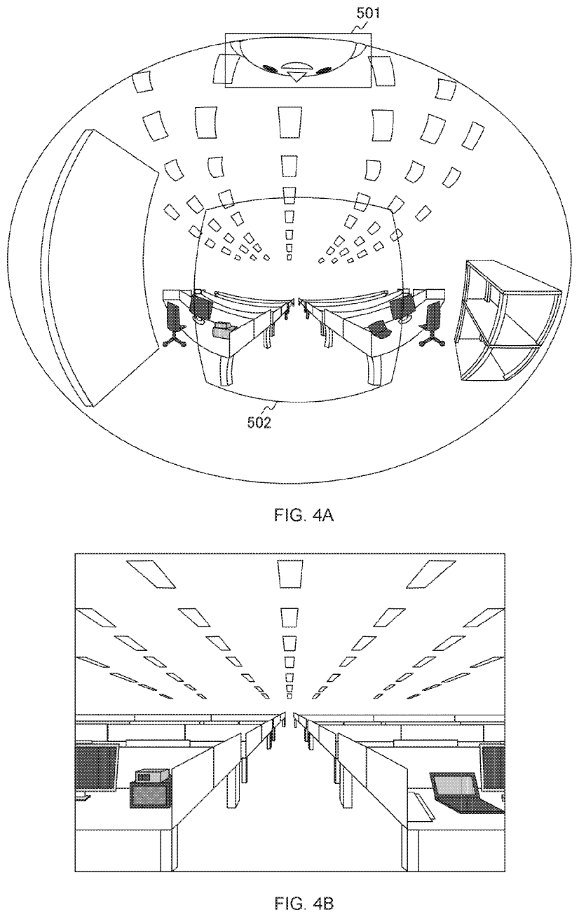

FIG. 4 is an illustration showing one example of a noticed region in the first embodiment of the present technology. The same illustration is one that shows an example in the case where a photographer has performed imaging in a state of having worn the imaging device 10. For this reason, the face of the photographer has been reflected to an upper portion of a screen. A part “a” in the same illustration is one that shows the whole image (frame) captured by the image sensor 200. Since it has been captured through the fisheye lens 100, it has become an image of a wide viewing angle. Regions 501 and 502 in the part “a” in the same illustration are those that show a face region of the photographer and a noticed region, respectively. In such a case, the specific person selecting section 311 can output a region on an upper end portion of a screen as a person region. Moreover, a part “b” in the same illustration is one in which, after having caused the image signal of the above-mentioned noticed region 502 to be outputted from the image sensor 200, distortion correction has been performed. In this connection, the size of the noticed region 502 can be made a size decided beforehand. In this way, the photographer has oriented the face and the line of sight to a region being noticed. Then, by detecting the orientation of a face or the like, a noticed region can be detected.

[Imaging Control]

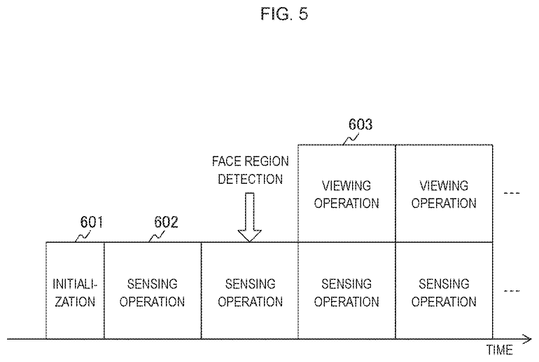

FIG. 5 is a diagram showing one example of imaging control in the first embodiment of the present technology. The same illustration is one that shows a control operation of the image sensor 200 in the image signal control section 320. First, the image signal control section 320 performs the initialization (601) of the image sensor 200. To this initialization, for example, the setting processing of an imaging mode of the image sensor 200 corresponds. Next, the image signal control section 320 performs control for a sensing operation (602). This sensing operation is an operation that detects a noticed region from the image signals outputted from the image sensor 200. In this sensing operation, a face region is detected from the image signals outputted from the image sensor 200, and, from this detected face region, the detection of a noticed region is performed. As mentioned in the above, this detection of the face region and the noticed region is performed by the noticed region detecting section 310.

In the case of having detected a noticed region with this sensing operation, in addition to the sensing operation, the image signal control section 320 performs control for a viewing operation (603). This viewing operation is an operation that reads out the image signals of a noticed region from the image sensor 200. This viewing operation is executed simultaneously with the sensing operation. That is, from the image sensor 200, two regions of a face detection region and a noticed region are outputted simultaneously. In this connection, to a noticed region becoming an object of the reading-out in the viewing operation, a noticed region having been detected in the sensing operation in the imaging before one time will be applied.

[Imaging Control Processing]

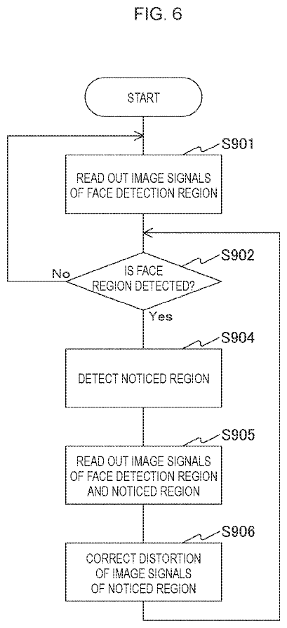

FIG. 6 is a diagram showing one example of a processing procedure of the imaging control processing in the first embodiment of the present technology. The processing in the same diagram is one that shows processing in the case where the face detection region is being fixed as described in FIG. 4. First, the imaging control section 300 performs the reading out of the image signals of a face detection region (Step S901). Next, the imaging control section 300 performs the detection of a face region from the read-out image signals of the face detection region (Step S902). In the case where the detection of a face region could not be done (Step S902: No), the imaging control section 300 executes the processing in Step S901 again.

In the case where a face region has been detected in Step S902 (Step S902: Yes), the imaging control section 300 detects a noticed region on the basis of the face region (Step S904). Next, the imaging control section 300 performs the reading out of the image signals of the face detection region and the noticed region (Step S905). Next, the imaging control section 300 performs the distortion correction of the image signals of the noticed region (Step S906). The image signals in which the distortion has been corrected are held in the storage 400. Thereafter, the imaging control section 300 executes the processing from Step S902 again.

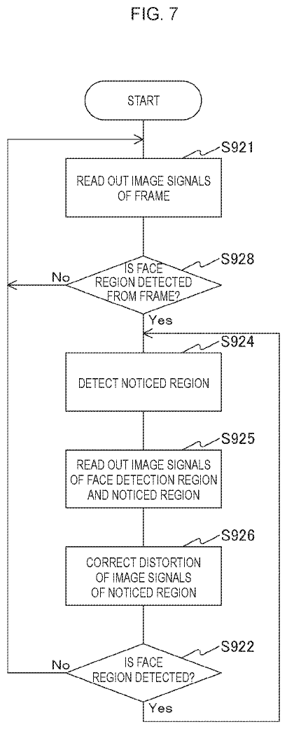

FIG. 7 is a diagram showing other example of the processing procedure of the imaging control processing in the first embodiment of the present technology. The same diagram is one that shows the processing in the case where the face detection region is not fixed. First, the imaging control section 300 performs the reading out of the image signals of a frame from the image sensor 200 (Step S921). Next, the imaging control section 300 performs the detection of a face region from the read-out image signals of the frame (Step S928). In the case where a face region has not been able to be detected (Step S928: No), the imaging control section 300 executes the processing in Step S921 again.

On the other hand, in the case where a face region has been detected (Step S928: Yes), the imaging control section 300 detects a noticed region (Step S924). Next, the imaging control section 300 performs the reading out of the image signals of the face detection region and the noticed region (Step S925), and performs the distortion correction of the image signals of the noticed region (Step S926). Next, the imaging control section 300 performs the detection of a face region from the read-out face detection region (Step S922). In the case where a face region has not been able to be detected (Step S922: No), the imaging control section 300 executes the processing from Step S921 again. On the other hand, in the case where a face region has been detected (Step S922: Yes), the imaging control section 300 executes the processing from Step S924 again.

In this way, according to the first embodiment of the present technology, by detecting a noticed region by the noticed region detecting section 310, only the image signals of the noticed region are made to be outputted from the image sensor, and the output of the image signals of a non-noticed region can be omitted. With this, the power consumption in the imaging device 10 can be reduced.

### 2. Second Embodiment

In the above-mentioned first embodiment, with assuming a case where a photographer wears the imaging device 10 and performs photographing, the photographer has been selected as a specific person. In contrast, a photographer may install the imaging device 10 at a separated position and may perform the photographing of an image including a plurality of persons. The second embodiment of the present technology is different from the above-mentioned first embodiment in a point that, in the case where a photographer is not clear, a specific person is selected.

[Noticed Region]

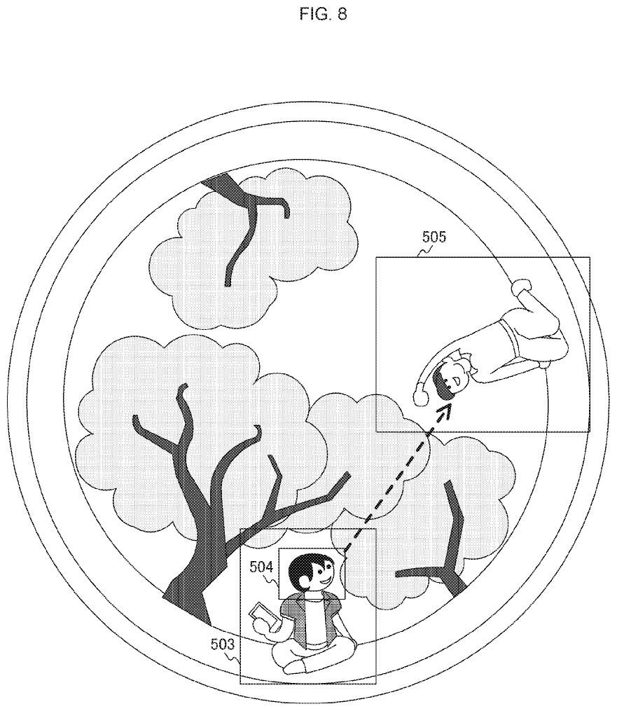

FIG. 8 is an illustration showing one example of a noticed region in the second embodiment of the present technology. The same illustration is one that shows an example of an image having been captured by the imaging device 10 having been installed at a position separated from a photographer. A region 503 shows a region of a specific person. This specific person is selected by the specific person selecting section 311 described in FIG. 3. As shown in the same illustration, in the case where a plurality of persons is included in the image signals outputted from the image sensor 200 and a photographer is not clearly decided, the specific person selecting section 311 can select one person of the plurality of persons and can output the region of the concerned person. For example, the specific person selecting section 311 can select a person designated by the photographer etc. as a specific person. The designation of this person can be performed, for example, by disposing a user interface that receives an operation input by a user, in the imaging device 10 and by designating the person through this user interface. From this region 503 of the specific person, a face detection region 504 and a noticed region 505 are detected in order.

[Imaging Control Processing]

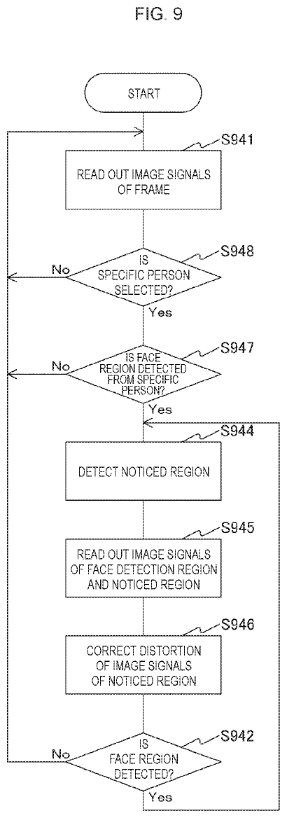

FIG. 9 is a diagram showing one example of a processing procedure of the imaging control processing in the second embodiment of the present technology. First, the imaging control section 300 performs the reading out of the image signals of a frame from the image sensor 200 (Step S941). Next, the imaging control section 300 selects a specific person from the read-out image signals of the frame (Step S948). In the case where a specific person has not been able to be selected (Step S948: No), the imaging control section 300 executes the processing in Step S941 again. On the other hand, in the case where a specific person has been selected (Step S948: Yes), the imaging control section 300 detects a face region from the image signals of the specific person (Step S947). In the case where a face region has not been able to be detected (Step S947: No), the imaging control section 300 executes the processing from Step S941 again.

On the other hand, in the case where a face region has been detected (Step S947: Yes), the imaging control section 300 detects a noticed region on the basis of the face region (Step S944). Next, the imaging control section 300 performs the reading out of the image signals of the face detection region and the noticed region (Step S945), and performs the distortion correction of the image signals of the noticed region (Step S946). Next, the imaging control section 300 performs the detection of a face region from the image signals of the face detection region (Step S942). In the case where a face region has not been able to be detected (Step S942: No), the imaging control section 300 executes the processing from Step S941 again. On the other hand, in the case where a face region has been detected (Step S942: Yes), the imaging control section 300 executes the processing from Step S944 again.

Since the constitution of the imaging devices 10 other than this is similar to that of the imaging device 10 in the first embodiment of the present technology, description is omitted.

In this way, according to the second embodiment of the present technology, even in the case where a specific person is not clear, such as in the case where imaging is performed by an imaging device disposed separately from a photographer, a specific person can be selected from the image signals of a frame. Then, on the basis of the face region of this selected specific person, a noticed region can be detected. With this, the selection of a specific person is made easy, whereby it is possible to improve convenience.

### 3. Third Embodiment

In the above-mentioned first embodiment, a noticed region has been detected from the face region of a photographer. In contrast, a noticed region may be detected from a gesture etc. of a photographer. The third embodiment of the present technology is different from the above-mentioned first embodiment in a point that a noticed region is detected from a region pointed by a photographer.

[Constitution of Noticed Region Detecting Section]

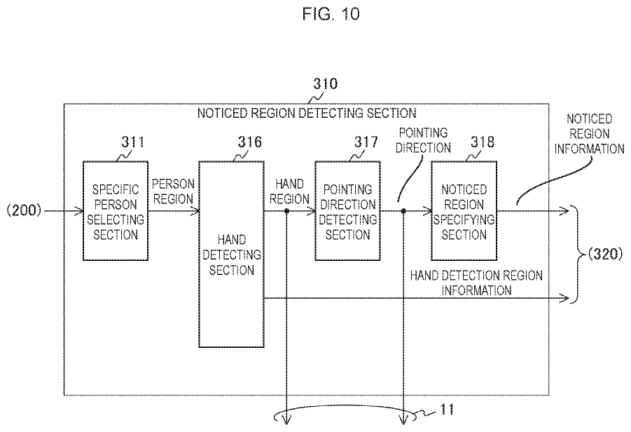

FIG. 10 is a diagram showing a constitution example of the noticed region detecting section 310 in the third embodiment of the present technology. As compared with the noticed region detecting section 310 described in FIG. 3, the noticed region detecting section 310 in the same diagram includes a hand detecting section 316 instead of the face detecting section 312. Moreover, it includes a pointing (or finger-pointing) direction detecting section 317 instead of the face orientation detecting section 313 and the line-of-sight detecting section 314. Moreover, the noticed region detecting section 310 in the same diagram includes a noticed region specifying section 318 instead of the noticed region specifying section 315. In this connection, the noticed region detecting section 310 in the third embodiment of the present technology outputs a hand region, a pointing direction, and noticed region information as imaging information. In this connection, the imaging information of the third embodiment of the present technology is not limited to this example. For example, it is also possible to output any one of the hand region, the pointing direction, and the noticed region information as imaging information.

The hand detecting section 316 is one that detects a hand region from a person region outputted from the specific person selecting section 311. This hand detecting section 316 outputs the detected hand region to the pointing direction detecting section 317. Moreover, this hand detecting section 316 outputs the detected hand region through the signal line 11 to the outside of the imaging device 10. In the detection of a hand region, publicly-known methods can be used. Moreover, from the image signals of the detected hand region, the hand detecting section 316 detects the position of the concerned region in a frame, and outputs it as hand detection region information to the image signal control section 320.

The pointing direction detecting section 317 is one that detects a pointing direction from the hand region outputted from the hand detecting section 316. This pointing direction detecting section 317 outputs the detected pointing direction to the noticed region specifying section 318. Moreover, this pointing direction detecting section 317 outputs the detected pointing direction through the signal line 11 to the outside of the imaging device 10. In the detection of a pointing direction, publicly-known methods can be used.

The noticed region specifying section 318 is one that outputs noticed region information. This noticed region specifying section 318 is different from the noticed region specifying section 315 described in FIG. 3 in a point of specifying a noticed region on the basis of the pointing direction outputted from the pointing direction detecting section 317.

In this connection, the image signal control section 320 in the third embodiment of the present technology performs the control of the output of the image signals of a hand detection region on the basis of hand detection region information outputted by the hand detecting section 316.

[Noticed Region]

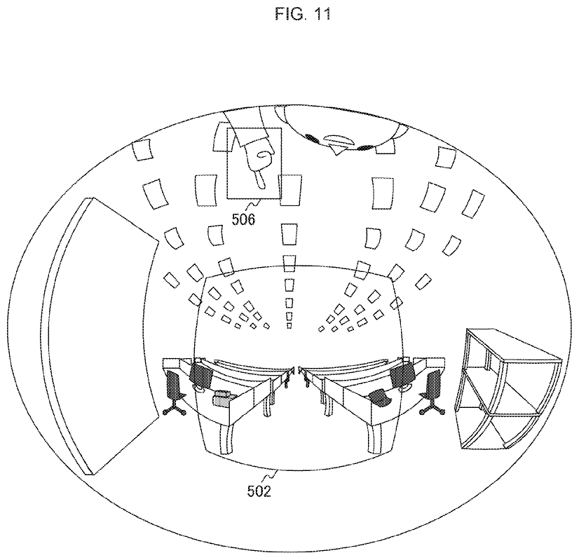

FIG. 11 is an illustration showing one example of a noticed region in the third embodiment of the present technology. The same illustration is one that shows a case of detecting a noticed region 502 by the pointing direction of a photographer. A region 506 in the same illustration shows a region of a hand of the photographer. The above-mentioned pointing direction detecting section 317 performs the detection of a pointing direction from this region 506.

[Imaging Control Processing]

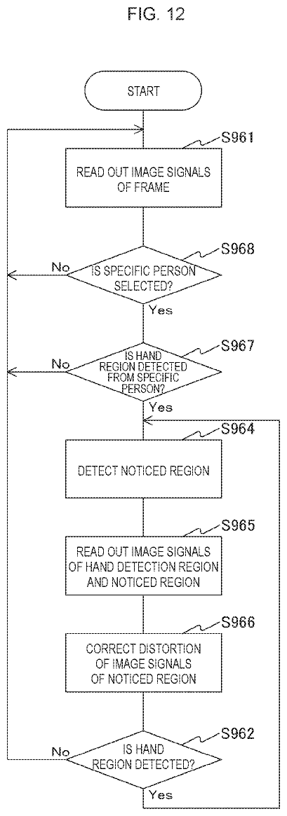

FIG. 12 is a diagram showing one example of a processing procedure of the imaging control processing in the third embodiment of the present technology. First, the imaging control section 300 performs the reading out of the image signals of a frame from the image sensor 200 (Step S961), and selects a specific person from the read-out image signals of the frame (Step S968). As this specific person, a photographer can be selected. In the case where a specific person has not been able to be selected (Step S968: No), the imaging control section 300 executes processing in Step S961 again. On the other hand, in the case where a specific person has been selected (Step S968: Yes), the imaging control section 300 detect a hand region from the selected specific person (Step S967). In the case where a hand region has not been able to be detected (Step S967: No), the imaging control section 300 executes processing from Step S961 again. On the other hand, in the case where a hand region has been detected (Step S967: Yes). The imaging control section 300 detects a noticed region from the detected hand region (Step S964).

Next, the imaging control section 300 performs the reading out of the image signals of the hand detection region and the noticed region (Step S965), and performs the distortion correction of the read-out image signals of the noticed region (Step S966). Next, the imaging control section 300 performs the detection of a hand region from the hand detection region (Step S962). In the case where a hand region has not been able to be detected (Step S962: No), the imaging control section 300 executes the processing from Step S961 again. On the other hand, in the case where a hand region has been detected (Step S962: Yes), the imaging control section 300 executes the processing from Step S964 again.

Since the constitution of the imaging devices 10 other than this is similar to the constitution of the imaging device 10 described in the first embodiment of the present technology, description is omitted.

In this way, according to the third embodiment of the present technology, by using the pointing direction of a photographer, the detection of a noticed region can be performed flexibly, and the convenience of a photographer can be improved.

### 4. Fourth Embodiment

In the above-mentioned first embodiment, at the time of causing image signals to be outputted from the image sensor 200, the detection of a noticed region has been performed always. In contrast, the detection of a noticed region may be performed as required. The fourth embodiment of the present technology is different from the above-mentioned first embodiment in a point of changing the frequency of the detection of a noticed region.

[Imaging Control]

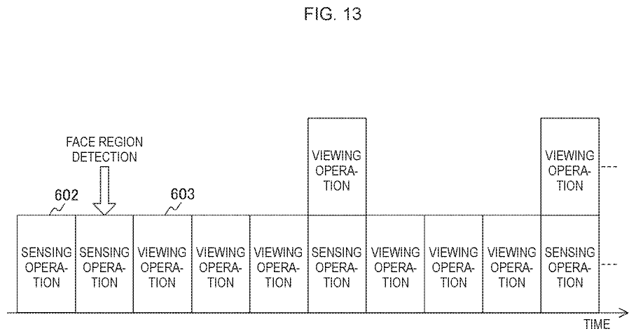

FIG. 13 is a diagram showing one example of the imaging control in the fourth embodiment of the present technology. The same diagram is one that shows an example in the case of changing the frequency of the sensing operation after having detected a face region. As shown in the same diagram, after having detected a face region, then, after having performed only the viewing operation three times, the viewing operation accompanied by the sensing operation is performed. Here, at the time of performing only the viewing operation continuously, with applying a noticed region having been detected in the sensing operation having been executed at the last, the reading out of image signals is performed. In the case of using the imaging device 10 for an application in which a noticed region is not changed frequently, such as a monitoring camera, the frequency of the sensing operation can be made low. With this, the detection frequency of a noticed region by the noticed region detecting section 310 is made low, whereby power consumption can be reduced.

Moreover, correspondingly to the change frequency of a noticed region, the frequency of the sensing operation can also be changed. For example, in the case where a region being noticed by a photographer changes frequently, the frequency of the sensing operation is made high. On the other hand, in the case where the renewal of a noticed region is not performed for a fixed period, the frequency of the sensing operation is made low. With this, correspondingly to the imaging situation of a photographer, the detection frequency of a noticed region can be changed flexibly, and the convenience of a photographer can be made to be improved. In this connection, the control method of the imaging is not limited to this example. For example, the sensing operation and the viewing operation can also be performed alternately.

In this way, according to the fourth embodiment of the present technology, by changing the detection frequency of a noticed region, the power consumption of the imaging device 10 can be reduced more.

### 5. Modified Exampled

In the above-mentioned embodiments, in the noticed region detecting section 310, a region being noticed by a specific person is detected as a noticed region. However, it is also possible to detect a region being noticed by a living thing other than a person. With this, for example, by detecting a region being noticed by animals, such as a dog and a cat, it is possible to output image signals in the concerned region.

As mentioned in the above, according to the embodiments of the present technology, by performing control for causing the image signals of a noticed region to be outputted from an image sensor that performs imaging of a wide viewing angle image, and, with respect to the image signals of a non-noticed region, by performing control different from that in the noticed region, it is possible to reduce the power consumption of an imaging device.

The above-described embodiments are examples for embodying the present technology, and matters in the embodiments each have a corresponding relationship with disclosure-specific matters in the claims. Likewise, the matters in the embodiments and the disclosure-specific matters in the claims denoted by the same names have a corresponding relationship with each other. However, the present technology is not limited to the embodiments, and various modifications of the embodiments may be embodied in the scope of the present technology without departing from the spirit of the present technology.

The processing sequences that are described in the embodiments described above may be handled as a method having a series of sequences or may be handled as a program for causing a computer to execute the series of sequences and recording medium storing the program. As the recording medium, a CD (Compact Disc), an MD (MiniDisc), and a DVD (Digital Versatile Disc), a memory card, and a Blu-ray disc (registered trademark) can be used.

Note that the effects described in the present specification are not necessarily limited, and any effect described in the present disclosure may be exhibited.

Additionally, the present technology may also be configured as below.
(1)

An imaging control device, including:

a noticed region detecting section that detects a noticed region from an image signal outputted from an image sensor, the noticed region being a region that is noticed by a specific living thing included in the image signal; and

an image signal control section that performs control of output from the image sensor of an image signal in the detected noticed region, and performs control different from control in the noticed region, for an image signal in a non-noticed region that is a region other than the noticed region.
(2)

The imaging control device according to (1), in which the image signal control section performs control for causing the image sensor to stop outputting an image signal in the non-noticed region.
(3)

The imaging control device according to (1), in which the image signal control section performs control for causing an image signal of the non-noticed region to be outputted on the basis of resolution different from resolution in the noticed region.
(4)

The imaging control device according to (1), in which the image signal control section performs control for causing an image signal of the non-noticed region to be outputted on the basis of a frame rate different from a frame rate in the noticed region.
(5)

The imaging control device according to any of (1) to (4), further including a distortion correcting section that corrects distortion of the outputted image signal in the noticed region.
(6)

The imaging control device according to (5), in which the image sensor outputs an image signal having been captured through a fisheye lens, and

the distortion correcting section corrects distortion of an image signal caused by the fisheye lens.
(7)

The imaging control device according to any of (1) to (6), in which the noticed region detecting section detects the noticed region on the basis of face information that is information with regard to a face of the specific living thing.
(8)

The imaging control device according to any of (1) to (6), in which the noticed region detecting section detects the noticed region on the basis of a pointing direction of the specific living thing.
(9)

The imaging control device according to any of (1) to (8), in which the noticed region detecting section selects the specific living thing from an image signal outputted from the image sensor, and detects the noticed region on the basis of the selected specific living thing.
(10)

The imaging control device according to (9), in which the noticed region detecting section selects a photographer as the specific living thing.
(11)

The imaging control device according to (9), in which in a case where a plurality of living things is included in an image signal outputted from the image sensor, the noticed region detecting section selects one of the plurality of living things as the specific living thing.
(12)

The imaging control device according to any of (1) to (11), in which the noticed region detecting section changes a frequency of detecting the noticed region.
(13)

The imaging control device according to any of (1) to (12), in which the specific living thing is a specific person.
(14)

An imaging device, including:

an image sensor;

a noticed region detecting section that detects a noticed region from an image signal outputted from the image sensor, the noticed region being a region that is noticed by a specific living thing included in the image signal; and

an image signal control section that performs control of output from the image sensor of an image signal in the detected noticed region, and performs control different from control in the noticed region, for an image signal in a non-noticed region that is a region other than the noticed region.
(15)

An imaging control method, including:

a noticed region detecting procedure that detects a noticed region from an image signal outputted from an image sensor, the noticed region being a region that is noticed by a specific living thing included in the image signal; and

an image signal control procedure that performs control of output from the image sensor of an image signal in the detected noticed region, and performs control different from control in the noticed region, for an image signal in a non-noticed region that is a region other than the noticed region.

### REFERENCE SIGNS LIST

10 imaging device
100 fisheye lens
200 image sensor
300 imaging control section
310 noticed region detecting section
311 specific person selecting section
312 face detecting section
313 face orientation detecting section
314 line-of-sight detecting section
315, 318 noticed region specifying section
316 hand detecting section
317 pointing direction detecting section
320 image signal control section
330 distortion correcting section
400 storage

1. An imaging control device, comprising:
a noticed region detecting section that detects a noticed region from an image signal outputted from an image sensor, the noticed region being a region that is noticed by a specific living thing included in the image signal; and
an image signal control section that performs control of output from the image sensor of an image signal in the detected noticed region, and performs control different from control in the noticed region, for an image signal in a non-noticed region that is a region other than the noticed region.

2. The imaging control device according to claim 1, wherein the image signal control section performs control for causing the image sensor to stop outputting an image signal in the non-noticed region.

3. The imaging control device according to claim 1, wherein the image signal control section performs control for causing an image signal of the non-noticed region to be outputted on a basis of resolution different from resolution in the noticed region.

4. The imaging control device according to claim 1, wherein the image signal control section performs control for causing an image signal of the non-noticed region to be outputted on a basis of a frame rate different from a frame rate in the noticed region.

5. The imaging control device according to claim 1, further comprising
a distortion correcting section that corrects distortion of the outputted image signal in the noticed region.

6. The imaging control device according to claim 5, wherein the image sensor outputs an image signal having been captured through a fisheye lens, and
the distortion correcting section corrects distortion of an image signal caused by the fisheye lens.

7. The imaging control device according to claim 1, wherein the noticed region detecting section detects the noticed region on a basis of face information that is information with regard to a face of the specific living thing.

8. The imaging control device according to claim 1, wherein the noticed region detecting section detects the noticed region on a basis of a pointing direction of the specific living thing.

9. The imaging control device according to claim 1, wherein the noticed region detecting section selects the specific living thing from an image signal outputted from the image sensor, and detects the noticed region on a basis of the selected specific living thing.

10. The imaging control device according to claim 9, wherein the noticed region detecting section selects a photographer as the specific living thing.

11. The imaging control device according to claim 9, wherein in a case where a plurality of living things is included in an image signal outputted from the image sensor, the noticed region detecting section selects one of the plurality of living things as the specific living thing.

12. The imaging control device according to claim 1, wherein the noticed region detecting section changes a frequency of detecting the noticed region.

13. The imaging control device according to claim 1, wherein the specific living thing is a specific person.

14. An imaging device, comprising:
an image sensor;
a noticed region detecting section that detects a noticed region from an image signal outputted from the image sensor, the noticed region being a region that is noticed by a specific living thing included in the image signal; and
an image signal control section that performs control of output from the image sensor of an image signal in the detected noticed region, and performs control different from control in the noticed region, for an image signal in a non-noticed region that is a region other than the noticed region.

15. An imaging control method, comprising:
a noticed region detecting procedure that detects a noticed region from an image signal outputted from an image sensor, the noticed region being a region that is noticed by a specific living thing included in the image signal; and
an image signal control procedure that performs control of output from the image sensor of an image signal in the detected noticed region, and performs control different from control in the noticed region, for an image signal in a non-noticed region that is a region other than the noticed region.
